(19) United States
(12) Patent Application Publication
(10) Pub. No.: US 2002/0129162 A1
(43) Pub. Date: Sep. 12, 2002

(54) Method, architecture, and apparatus for dynamic content translation and switching

(76) Inventors: Gregory M. McGregor, Martinez, CA (US); Mark Allen Shaw, San Jose, CA (US)

Correspondence Address: John T. Whelan, 3375 Bayside Road, Huntingtown, MD, 20639, US

(21) Appl. No.: 09/991,899

(22) Filed: Nov. 23, 2001

Related U.S. Application Data
(60) Provisional application No. 60/252,519, filed on Nov. 22, 2000.

(51) Int. Cl. G06F 15/173

(52) U.S. Cl. 709/238

(57) ABSTRACT

This document outlines a new and novel concept for an internet infrastructure component system that allows companies to dynamically translate and switch content on the fly by creating a control channel which “rides” on top of existing protocols used in the internet and other communications systems today.

### CROSS REFERENCE TO RELATED APPLICATION

This application is related to and claims priority under 35 U.S.C. §119(e) from U.S. Provisional Application No. 60/252,519, filed Nov. 22, 2000, the entire contents of which are hereby incorporated by reference.

### BACKGROUND OF THE INVENTION

The internet and communications systems are growing faster than ever and with this growth comes new growing pains. Many of these growing pains are simply due to a lack of a mature and stable infrastructure that hosters have to build upon Hosters are further frustrated with a general lack of profitability based on the high cost of actual procurement of current infrastructure and/or the unsatisfactory nature of being “locked-into” an outsourced provider of hosting services. Many companies find themselves building out infrastructure with only the rudimentary tools that are available to them. Unfortunately, only the fundamental building blocks such as generic operating systems are available for use now, with normal server class computers, compilers, switches and mass storage devices being the predominant tools that exist today to accomplish these tasks. Combining these basic elements leaves many companies having to engineer most all of their service or product from the ground up as partial or ad hoc solutions which are generally static devices which are not scalable and are expensive, in terms of development, day-to-day operations and maintenance.

Moreover, many companies hire a rash of contractors and internal engineers to begin cobble together solutions using scripts to inefficiently bind together existing switches and servers while desperately attempting to figure out how to build out a data centers to house the solution. Such systems decrease the stability of the infrastructure, decrease the performance of such infrastructure, increase costs in terms of the amount of oversight on such infrastructure and the building of such solutions.

Some of the initial fundamental design issues that revolve around building out of a data center are how many transactions, in any given time frame, must be handled, how much bandwidth will this require and how to keep the overall system up and running with a minimum of human intervention. Estimation of bandwidth is a costly problem for users as this will normally require the purchaser of bandwidth to “estimate” his or her bandwidth requirements and commit, often for substantial periods, to hefty minimum payments Any time a user exceeds these minimum commitments they will usually pay at a premium price. Such tasks are typically not simple to complete and require constant maintenance. Further acerbating this problem is the fear by hosters of so called “flash crowds”, that is, those events which generate very large traffic events such as Michael Jordan's return to the NBA. Since these events are very difficult to anticipate, many hosters actually build in additional capacity and pay for such capacity in the form of increased minimum commitments even when they to not expect to fully utilize such capacity.

Once a company decides to build out a data center or even a simple set of servers for a given service, it is a rather easy in concept to buy many computers to put in racks and start business. What is not as trivial is how those computers work together to form a robust, stable and high performance service. This is called QoS or Quality of Service in the industry. For example, some components exist today such as switches. Switch-based manufacturers include Alteon and Arrowpoint/Cisco. These switches allow for computers to be grouped and segmented based on services. More advanced switches actually perform health checking of various applications, latency between devices and other checks which attempt to ensure that the service is robust. This means that if a server is higher in latency, a different server is chosen It also means that if a server is down or tells the switch that it is not healthy, that it is automatically taken out of the network. In addition to switch-based QoS solutions some manufacturers have programmed normal computers to shunt requests from such computer to another server or server farm. Server-based manufacturers include F5 and Intel. Unfortunately, such server-based solutions do not allow for dynamic switching of requests from one server or server farm to another except to the extent of simple latency checking. Short of these types of equipment, there are simply no other types of equipment needed to solve these problems, available today off the shelf.

Accordingly, there exists a need in the industry for fundamentally different networking solutions That is, normal switches, routers, caches and serving solutions focus on “flowing” bits through the network better and faster. Typical networking works by listening to a request for content and sending that content back through that same network path. There is a need for a method and apparatus capable of translating and switching dynamic content such that when a request comes into such method and apparatus a better connection point/serving point is returned to the client and the connection is broken, whereby the client then re-establishes a connection with a “better” serving point or network path/route.

Moreover, previously known networking components only care about the request they just received and how to get it to the “best” server in it's list of servers. Another common issue with this approach is bandwidth, that is, what happens when your service reaches peak bandwidth. Traditionally, companies quickly purchased additional bandwidth and machines to fill the requests, which is an expensive and time-consuming problem. Another technique typically used is to build the network to handle what the calculated peak bandwidths would be. This is not cost effective as even the most infinitesimal mis-estimation can cause such purchasers to pay premium peak costs for such additional bandwidth. There are no solutions today that truly address this issue.

### SUMMARY OF THE INVENTION

To address the foregoing and other disadvantages of the various architectures previously known in the art and to fulfill the above-stated needs in the industry, applicants have invented a new and novel method and apparatus of dynamic content translation and switching (“DCTS”). As discussed in detail below, according to the present invention, DCTS is a form of an internet control channel that permits the re-establishment connections for clients on the fly for a variety of reasons, Further according to the present invention, DCTS has complete control of where, what, why and when a client should see what they are requesting.

According to a presently preferred embodiment of the present invention, as set forth and described in detail below, the invention comprises a method of selecting an optimal routing path for internet data comprising the steps of generating a request at a client; analyzing the request in accordance with at least one rule set; and routing the request to a server for fulfillment of the request based on the results of the analysis

### BRIEF DESCRIPTION OF THE DRAWINGS

The present invention will now be described in detail with reference to the accompanying drawings, in which:

FIG. 1 depicts a for logic flow of a sample request fulfillment in accordance with the present invention;

FIG. 2 depicts a for logic flow of a sample request fulfillment in accordance with the present invention;

FIG. 3 illustrates an example of an application for Internet content and serving locations is according to the present invention; and

FIG. 4 illustrates an example of a simple logic tree illustrating the method present invention.

### DETAILED DESCRIPTION OF THE INVENTION

The present invention is directed to a novel and nonobvious method and apparatus for dynamic content translation and switching (“DCTS”). Broadly speaking, DCTS is a means operative, for example on the OSI application layer (Layer 7), by which to solve request redirection needs. By capitalizing on the fundamental differences DCTS offers over previously known networking solutions, the present invention is able to provide a large and broad feature set for building out infrastructure. As discussed in detail below, DCTS can also be used to provide off the shelf capabilities.

Because, as discussed above, bandwidth is limited and thus has become an expensive commodity, the present invention provides a network component, a DCTS to be specific, that understands the current threshold of the network. When bandwidth becomes scarce, the DCTS re-routes the request to a completely different service provider. More specifically, the DCTS of the present invention has the capabilities to not only re-route requests to additional data centers within the same organization or service provider it has the ability to translate the request and re-route the request such that the request can be handled by an user server or server farm, third party service provider and multiple user server or server farms and/or multiple third party service providers.

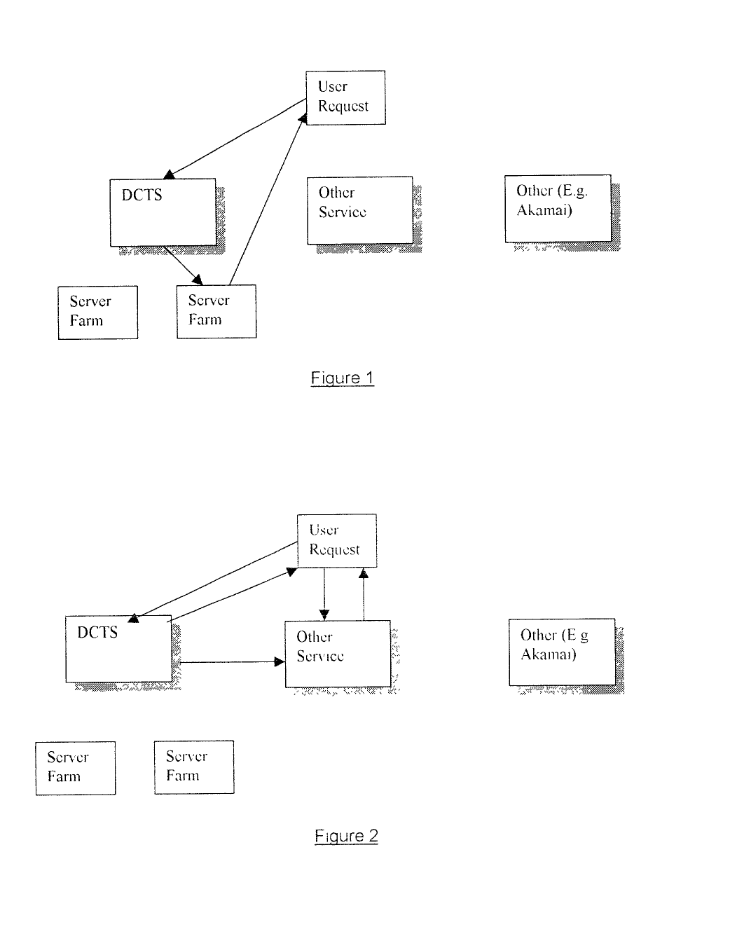

To assist in clarifying exactly what this means, consider the following example with reference to FIG. 1, which shows a request being fulfilled by Company X, and FIG. 2, which shows a request being fulfilled by a third party service provider or content delivery network (“CDN”). Let's say that company X builds a data center and figures that they have capabilities to serve up to 1 gigabit of requests and service Let's say that company X hosts its own content from its own data center and has an agreement with other companies such as Akamai or Digital Island whereby overflow is capable of being served by those service providers. Given a DCTS component according to the present invention, company X would have the ability to configure rule sets on the DCTS unit regarding it's service. These rule sets could include, for example, when to route and translate requests to these other companies. By way of example only and not limitation, the types of rules that might be included in this type of rule set are: hitting a certain peak of throughput, time-of-day, type of content, or even which other service provider has the lower cost per Megabyte served for the content in question. These rule permit company X to have the ability to “commoditize” those services from other services providers, a feature that can single handedly assist in creating profitability for some companies such as HTTP hosting and streaming hosting companies. Once these rules are established the DCTS takes requests and routes the requests to the most “healthy” machine in the local network until one or more of the rule sets is triggered. At that time, the DCTS kicks in and begins its translating and re-routing capabilities for that extra content. It should be noted that according to the present invention a DCTS could translate any, some or all content requests if so desired.

Of course additional rule sets may be employed without departing from the spirit or scope of the present invention. Such rule sets may include, for example, rule sets based on cost, business rules, traffic load, geography, demographics, health of system and network, etc.

DCTS is a deterministic end point for client requests at which point the connection to the client is broken and re-established at a presumably better or different location. As used herein, the term “deterministic end point” means a server that can handle an end user client request. DCTS is also far reaching in that it may reside in end user client ip and no-ip network points. For instance, mobile communication devices such as Palm computers traveling, IP radio networks, and newer wireless networks (CDPD, 3G, 2.5G, 4G etc . . . ) This would allow end user devices to make decisions before establishing connections.

The DCTS according to the present invention is fundamentally different than other technologies such as switches and routers. Switches and routers deal with optimizing flows and routes to content. Given a bad area of a network a smart switch or router might flow the traffic through a different route. The present invention accepts client requests as a deterministic end point of a route. This request is almost always a lightweight request for a given asset or piece of content. That is, the time it takes to process the request is significantly less that the time it takes to fulfill the request. From there, the DCTS replies with where the client should receive the content. It then “breaks” the current route and connection having the client re-establish a connection with a better serving point. By offering this fundamental difference over conventional technologies, the present invention has the ability to complete throw out all routes and calculate the best route for that particular client. This allows DCTS to perform a number of technical operations about what the client is requesting These include, for example, health, entry points into other non-routable networks from the current serving location, and many other features.

Because the DCTS technology embodying the present invention is a critical end point and decision point in the network, the DCTS preferably has complete control over every request coming from a client. That is, the DCTS dynamically makes decisions regarding how, what, where, why and when content should be served. Because the connection is broken and is re-established elsewhere, the DCTS can route clients to different types of content than originally requested It also means that the DCTS can deny access by simply not providing a route or redirect to the client as to where to reconnect for service.

Although the DCTS accord to the present invention works with IP based networks, the DCTS also works with other network types as well. That is, other networks such as wireless or video networks that translate to some gateway into IP are all subject to DCTS. DCTS also may sit within those non IP based networks, such as wireless (AMPS/2.5G/3G/4G and beyond), radio or video broadcast and other types of networks. Accordingly, DCTS provides a fundamental means to provide a client a response as to where to receive content. (A “client”, as used herein, refers to an application program that establishes connections for the purpose of sending requests, as will be understood by those skilled in the art).

Furthermore, DCTS understands the cost associated with fulfilling a given request. This means that when least path costing is turned on, the DCTS system has the ability to route requests to the least cost fulfillment service center. This can happen a number of different ways. For instance, one service provider might be a satellite IP provider (such as PanAmSat) and another a terrestrial IP (such as Akamai) for instance. If we assume that we are looking at RTSP (Real Time Streaming Protocol) and a video request, the DCTS system understands that it is more cost effective to fulfill the first requests locally from the local system it belongs to. However, as the content heats up, meaning bandwidth is consumed quicker, the DCTS might translate or route requests via the RTSP protocol to Akamai for the next level of cost effective serving. When the content becomes more popular it might make cost sense to have it broadcast around the country via PanAmSat for purposes of cutting bandwidth and serving costs down. This very feature greatly increases a service provider's ability to create a cost effective service. The present invention also supports the notion of commoditizing the service providers, in that combined with the costing and other rule sets, DCTS routes to the least cost provider. This provides the ability for companies to begin to control cost and procure the best services

Alternatively, the rule might be hard in that all traffic travels a certain path which might be PanAmSat. An example might be the Victoria Secrets web cast. This is the most popular web cast to date. It makes sense for costing to broadcast this from the beginning without using up bandwidth before making that decision.

Further because DCTS is a critical decision point in the network, DCTS also can “look ahead” in the network at all the possibilities to send a client for viewing content. If for some reason a given network is reaching capacity, DCTS can simply overflow user requests to another network or area of the current network. This type of decision might be derived from, for example, available bandwidth database query, storage query, number of transactions and many other types of criteria. The present invention thus significantly improves management of business costs. In addition, in some cases a given service provider might be offering specials on bandwidth and serving content. Time based switching can take advantage of this feature by translating/re-routing requests in that time space to that service provider. Other time rules for DCTS may include, for example, time of day associated with each type of service request.

Since DCTS has the ability to return not only where a client should receive service it can also redirect the client to a different piece of content. DCTS thus allows for marketing to advertise directly to the end user client making the request. Therefore, in accordance with the present invention dynamic targeted advertising insertion is not only possible but greatly facilitated.

Because DCTS is, for example, an endpoint at Layer 7 in the OSI model, DCTS sees the “entire” request from the client. This functionality different that any other switching technology known to date. Specifically, DCTS knows what the end client is requesting and has the ability to locate the “best” and most “healthiest” content to fulfill that request Types of health checking include, for example, checking to see if the content is on a given cache or serving location, that the hardware is up and running that will serve the content or that the actual software required to serve the content is up and running at the serving location.

Since DCTS is a decision point, DCTS has the ability to look at a number of possible serving locations for a given request. This means that DCTS must make a decision as to which of those locations are appropriate. In addition to health checking, as described above, the present invention builds in “request weighting”. This means that through the setup of DCTS, the present invention can offer preferred serving locations based on a number of criteria Those criteria could be based on percentage or any number of other methods.

Moreover, DCTS is a decision point, DCTS can act as a fail over for faulty hardware, switches, routers, software and any other devices that are directly in the serving path. That is, the present invention may take information given out by switches, servers, and software services and identify optimal serving locations and/or content types/bandwidths as a result. Thus, when a server or other system component fails, the DCTS of the present invention allows user requests to go to different serving points, thus avoiding the failed hardware.

DCTS Technical Architecture

DCTS can be applied to a number of protocols that exist today on the internet. Some of these protocols include, for example, RTSP and HTTP. For illustrative purposes only, reference will be made to the RTSP and HTTP protocols throughout the following architecture examples.

Resource Access

Typically throughout the internet an URL or Universal Resource Locator is used to uniquely locate a given content or asset item. Many service providers use URL's as the starting point to a given service, asset or content item. In the service scenario, the URL may only start the user in the service and the service could then be managed completely via that same URL with various session management. Session management is not a new concept and is typically done with expiration and internet cookies DCTS can be applied to all of these scenarios. DCTS works with content, assets and virtual services. In the later DCTS would fit a group in the ASP market.

One method by which DCTS can be applied is translating URL/URIs such that the request itself is re-routed to another service provider that has that service, asset or content item. This can be as simple as changing the host name for which to service the request.

As an example we might have service X such that it's URL might be:

http://www.somecompany.com/X

Given a rule that is triggered in the rule file for DCTS, the DCTS might translate the URL into the following:

http://www.othercompany.com/X

Again. this is a very simple case but shows how if there are more than one service provider or internet resource that has service X, this can easily be accomplished.

Other complicated scenarios exist where a service provider, such as Akamai, has a defined URL format that includes the original URL embedded into it. For these types of cases, the DCTS will need to perform a very detailed translation algorithm to create a seamless connection between the requester and the third party hosting the content. Specifically in the Akamai case, the embedded URL is used by Akamai to make sure the content it has is the most fresh and if not it collects that asset via the original URL. Therefore, the DCTS system has to be aware of which requests it should serve no matter what such as to a sister service provider.

Protocol Translations

Many protocols have the ability to re-direct users to a different URL for the purposes of having the request fulfilled. As an example, the HTTP protocol has a built in mechanism called redirect that allows the web site to redirect an URL to another completely different URL. These basic capabilities allow for temporary, single or permanent redirection to another asset. RTSP is another protocol that allows something similar. RTSP can return a redirect with valid time span for a given presentation to a completely different RTSP URL.

Taking advantage of these types of built in protocol level assists and enhances the DCTS system of the present invention. The DCTS system with all of its rule sets could easily translate URL's and route them on demand or re-route protocol requests via the specific protocol. DCTS does support HTTP and RTSP redirection to other equivalent protocol services. This is very useful in the case of RTSP where objects are typically extremely bandwidth intensive. In this case, the available bandwidth is likely to be used more quickly and off loading additional video/audio or other real-time data can be done at the protocol layer for the DCTS.

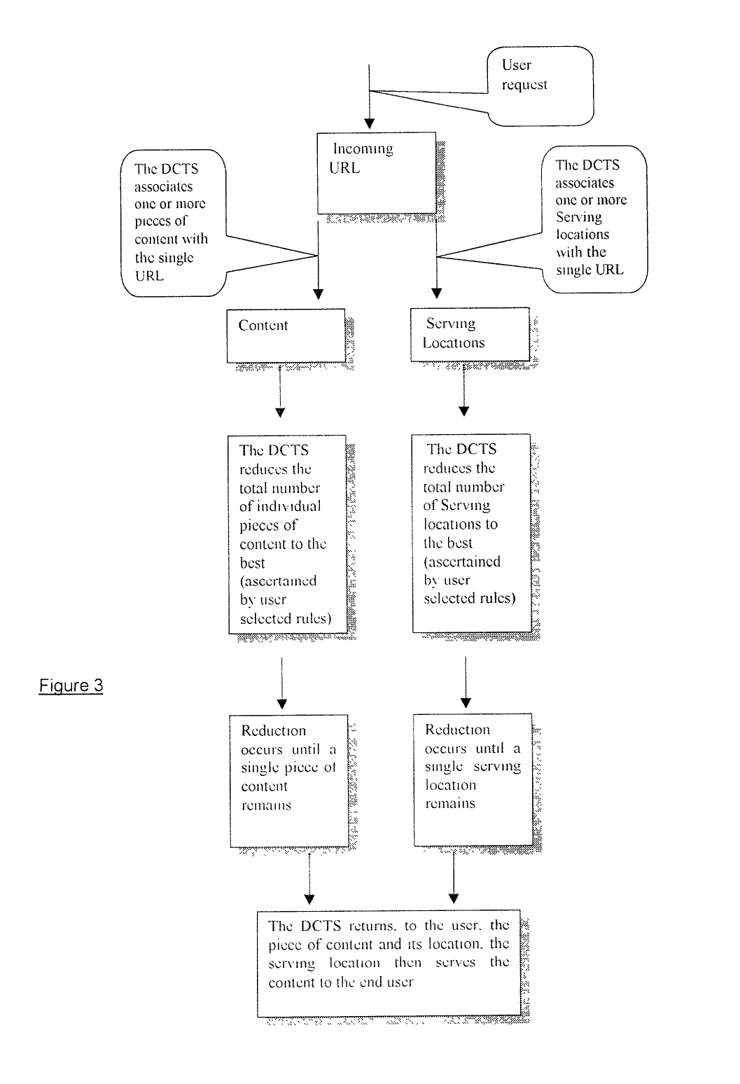

An example of an application for internet content and serving locations is according to the present invention is illustrated in FIG. 3.

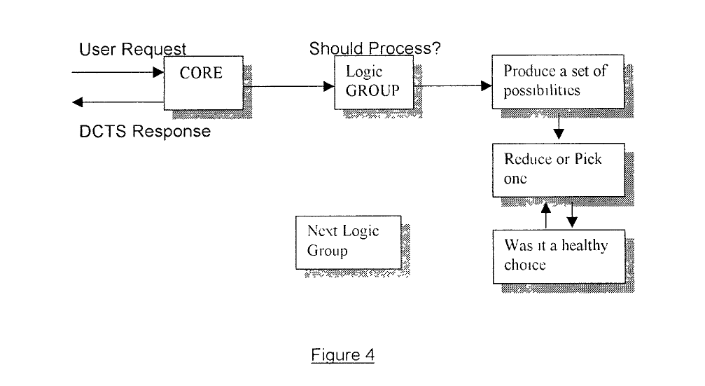

An example of a simple logic tree illustrating the present invention is shown in FIG. 4. As shown therein, a User Request comes to a CORE implementation of DTCS. This could be an HTTP or RTSP request. From there the CORE asks a series of Logic Groups if they wish to process the request. This grouping provides for flexibility in decision trees. Once a group is chosen, the DCTS could produces a set of possible serving points based off of the request, then pick one from the set and determine if it was a good choice. If the choice was not good, the DCTS could simply pick another and so on. DCTS could also implement more advanced logic flows without departing from the spirit or scope of the present invention but this diagram provides a fundamental view of DCTS logic

Once a given URL is selected that represents where the content is located for the end user client to view, an appropriate protocol response is returned from the DCTS logic. In the case of HTTP it performs an HTTP 300 series redirect to send the client to the content. However, it uses a 302 for the most part so that the client will always re-connect back to the DCTS logic for the same asset. In the case of RTSP, the DCTS logic uses an RTSP REDIRECT command to redirect the client. In the case of MMS for Microsoft, ASX metafiles can be returned. In the case for Quicktime, .MOV files can be returned or RTSP depending on the connection. These are just some of the means by which the DCTS “redirects”/“reroutes” a user, breaks the connection and tells the client where to re-connect. Again, it should be noted that in accordance with the present invention Redirects are applicable to other communication networks such as wireless networks and non-ip based networks

The present invention has been described above in the context of the presently preferred embodiments known to the inventors. Of course, other embodiments and variations will be apparent to those of skill in the art without departing from the spirit or scope of the present invention.

What is claimed is:

1. A method of selecting an optimal routing path for internet data comprising the steps of:
generating a request at a client;
analyzing said request in accordance with at least one rule set; and
routing said request to a server for fulfillment of said request based on the results of said analysis.
